(19) United States
(12) Patent Application Publication
(10) Pub. No.: US 2024/0271729 A1
(43) Pub. Date: Aug. 15, 2024

(54) TUBE CONNECTOR

(71) Applicants: NISSAN NORTH AMERICA, INC., Franklin, TN (US); JAC PRODUCTS, INC., SALINE, MI (US)

(72) Inventors: Gregory BYRNE, Novi, MI (US); Christian HERRINGTON, Walled Lake, MI (US); Nicholas TRIFONOFF, Commerce TWP, MI (US)

(21) Appl. No.: 18/169,637

(22) Filed: Feb. 15, 2023

(51) Int. Cl. F16L 37/08

(52) U.S. Cl. CPC F16L 37/08

(57) ABSTRACT

A tube connector that includes a cylindrically shaped body having a hollow interior defining a cylindrical inner surface therein. The cylindrically shaped body has a first end with a first opening and a second end with a second opening. The first and second openings are both open to the hollow interior. The cylindrically shaped body has a pipe aligning structure within the hollow interior spaced apart from the cylindrical inner surface dimensioned and shaped to receive a hollow pipe and center the hollow pipe with the hollow interior.

### BACKGROUND

### Technical Field

The present disclosure generally relates to a tube connector. More specifically, the present disclosure relates to a tube connector that is dimensioned and shaped to connect a first pipe to a second pipe.

### Background Information

Structures that include a plurality of pipes are typically connected via mechanical threaded engagements where an end of a first pipe has internal threads and an end of a second pipe has external threads such that the external threads engages the internal threads and is drawn into the first pipe. This structural arrangement is unforgiving and makes no provisions for two pipes that might be slightly mis-aligned or are too short to contact one another for threaded engagement.

### SUMMARY

One object of the present disclosure is to provide a tube connector with structures that join two pipes together that may be slightly mis-aligned with one another and/or may not be of sufficient length to directly contact one another.

In view of the state of the known technology, one aspect of the present disclosure is to provide a tube connector with a cylindrically shaped body having a hollow interior defining a cylindrical inner surface therein. The cylindrically shaped body has a first end with a first opening and a second end with a second opening. The first and second openings are both open to the hollow interior. The cylindrically shaped body has a pipe aligning structure within the hollow interior spaced apart from the cylindrical inner surface dimensioned and shaped to receive a hollow pipe and center the hollow pipe with the hollow interior.

### BRIEF DESCRIPTION OF THE DRAWINGS

Referring now to the attached drawings which form a part of this original disclosure:

FIG. 1 is a perspective view showing a tube connector with a first pipe inserted into a first end and a second pipe inserted into a second end in accordance with an exemplary embodiment;

FIG. 2 is another perspective view showing the tube connector with the first and second pipe removed showing one of two pipe aligning structures within the tube connector in accordance with an exemplary embodiment;

FIG. 3 is an end perspective view of the tube connector with one pipe inserted into the second end of the tube connector showing another of the pipe aligning structures visible through the first end of the tube connector in accordance with an exemplary embodiment;

FIG. 4 is another perspective view of the tube connector showing the second pipe aligning structure within the hollow interior of the tube connector and visible through an opening at the second end of the tube connector in accordance with an exemplary embodiment;

FIG. 5 is a cross-sectional view of the tube connector taken along the line 5-5 in FIG. 4 showing a wall that divides the hollow interior of the tube connector into first and second hollow spaces with a first of the pipe aligning structures in the first hollow space and the second of the pipe aligning structures in the second hollow space in accordance with an exemplary embodiment;

FIG. 6 is an end view of the first opening in the first end of the tube connector showing the first pipe aligning structure having an overall X-shape in accordance with an exemplary embodiment;

FIG. 7 is a cross-sectional view with one cut taken along the line 7-7 in FIG. 1, with portions a fastener structure removed to show a fastener that extends through a portion of the fastening structure and through an opening in one of the pipes retaining the pipe to the tube connector in accordance with an exemplary embodiment; and

FIG. 8 is another cross-sectional view similar to FIG. 5 showing a first pipe inserted into the first end of the tube connector, a second pipe inserted into the second end of the tube connector and further showing the wall and the pipe aligning structure within the hollow interior of the tube connector in accordance with an exemplary embodiment.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

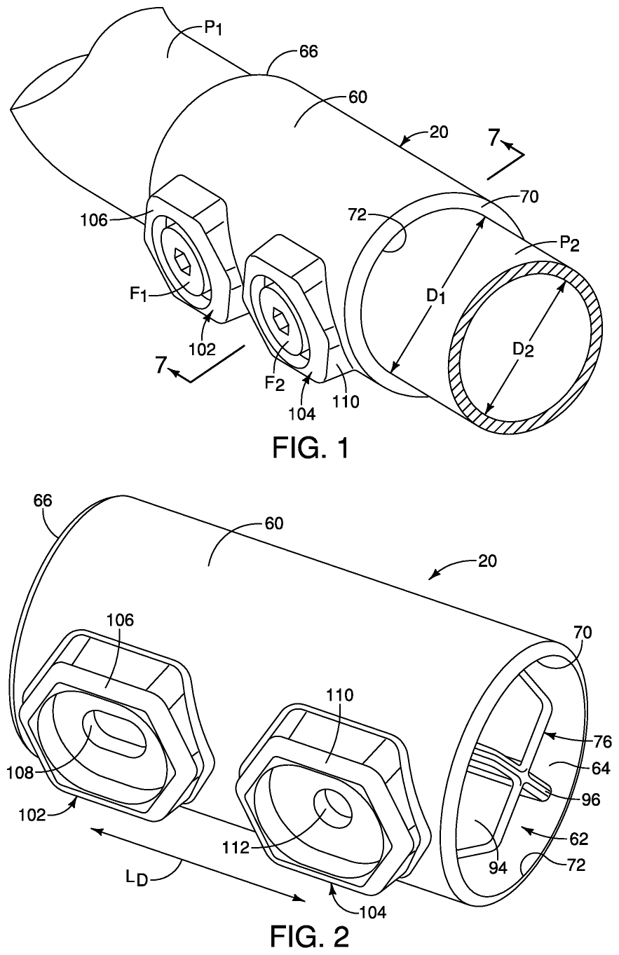

Referring initially to FIG. 1, a tube connector 20 is illustrated in accordance with a first embodiment. The tube connector 20 is dimensioned and configured to connect a first pipe P₁ to a second pipe P₂.

As shown in FIG. 2 with the first pipe P₁ and the second pipe P₂ removed, the connector 20 basically includes a cylindrically shaped body 60 that has a hollow interior 62. The hollow interior 62 defines a cylindrical inner surface 64.

The cylindrically shaped body 60 has a first end 66 with a first opening 68 and a second end 70 with a second opening 72. The first opening 68 and the second opening 72 are both open to the hollow interior 62, but at opposite ends thereof. The cylindrically shaped body 60 includes a pipe aligning structure 76. The pipe aligning structure 76 is located within the hollow interior 62 and is spaced apart from the cylindrical inner surface 64 of the cylindrically shaped body 60. The pipe aligning structure 76 is dimensioned and shaped to receive, guide and center the first pipe P₁ (a hollow pipe) into the first end 66. The pipe aligning structure 76 is also dimensioned and shaped to receive, guide and center the second pipe P₂ (another hollow pipe) into the second end 70 of the cylindrically shaped body 60.

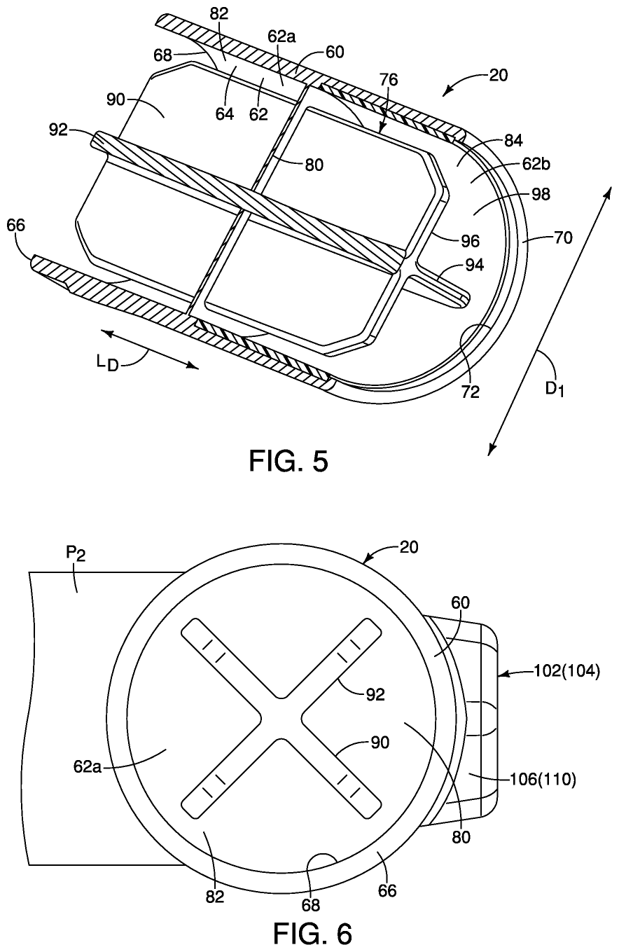

As shown in FIGS. 5 and 8, the hollow interior 62 of the cylindrically shaped body 60 includes a wall 80 that divides the hollow interior 62 into a first portion 82 and a second portion 84, generally equal in size. In the depicted embodiment, the wall 80 separates the first portion 82 from the second portion 84 of the hollow interior 62. In the depicted embodiment, the wall 80 is perpendicular to a lengthwise direction L_{D} of the cylindrically shaped body 60 and can be centered between the first end 66 and the second end 70. It should be understood from the drawings and the description herein that the wall 80 is not required to be centered between the first end 66 and the second end 70 but can alternatively be off-center between the first end 66 and the second end 70, depending upon the desired usage and requirements of the tube connector 20.

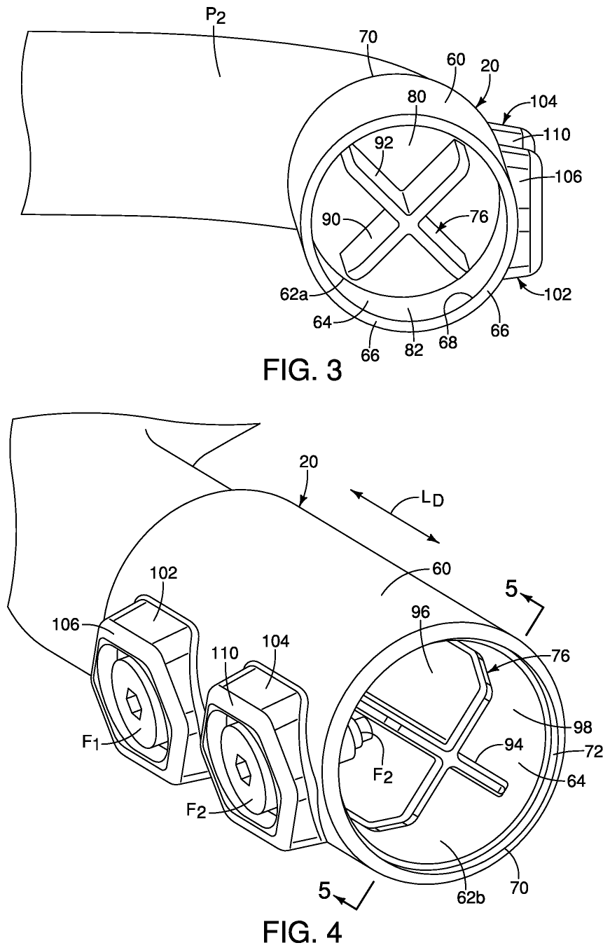

The wall 80 further divides the hollow interior 62 into a first hollow space 62a accessed by the first opening 68 and a second hollow space 62b accessed by the second opening 72. as shown in FIGS. 5 and 8. As shown in FIGS. 2-6 and 8, within the first hollow space 62a, the pipe aligning structure 76 includes a first elongated projection 90 and a second elongated projection 92 that extends outward from the wall 80.

The first and second projections 90 and 92 extend from the wall 80 through the first hollow area 62 to a location proximate the first opening 68 with the first and second elongated projections 90 and 92 defining an X-shape as viewed through the first opening 68.

Within the second hollow space 62b, the pipe aligning structure 76 also includes a third elongated projection 94 and a fourth elongated projection 96 that extends outward from the wall 80. More specifically, the third and fourth projections 94 and 96 extend from the wall 80 through the first hollow area 62 to a location proximate the second opening 72 with the third and fourth elongated projections 94 and 96 defining an X-shape as viewed through the second opening 72.

The first and second elongated projections 90 and 92 are dimensioned such that the first pipe P₁ can easily slip around the first and second elongated projections 90 and 92. In other words, the width of each of the first and second elongated projections 90 and 92 is slightly smaller than an inner diameter of the first pipe P₁.

Similarly, the third and fourth elongated projections 94 and 96 are dimensioned such that the second pipe P₂ can easily slip around the third and fourth elongated projections 94 and 96. In other words, the width of each of the third and fourth elongated projections 94 and 96 is slightly smaller than an inner diameter of the second pipe P₂.

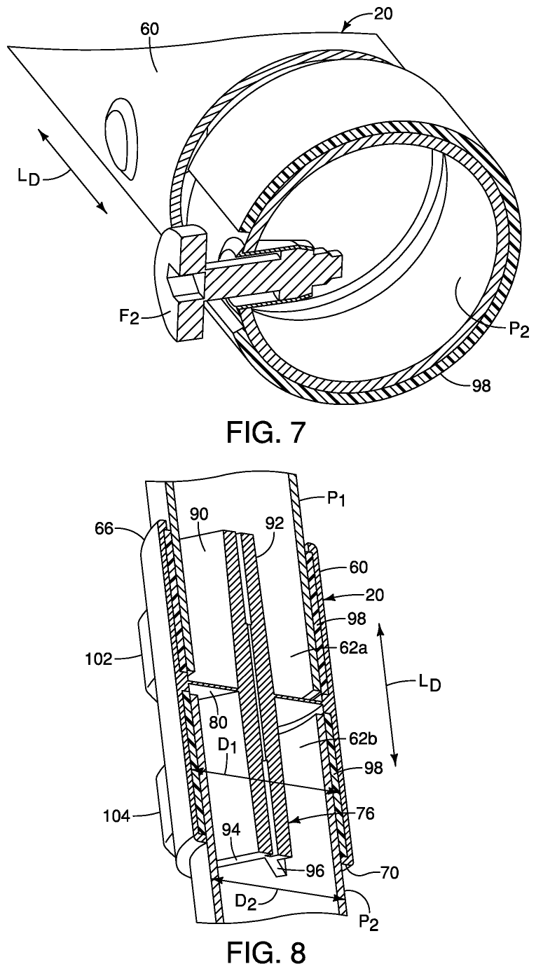

As shown in FIGS. 4, 5, 7 and 8, a portion of the cylindrical inner surface 64 is lined with a compressible and resilient elastic material 98 that serves as cushioning for the first pipe P₁ and the second pipe P₂ once installed within the hollow interior 62 of the cylindrically shaped body 60. Once centered within the first and second hollow spaces 62a and 62b, the first pipe P₁ and the second pipe P₂ are cushioned by the material 98 within the cylindrically shaped body 60, as is described further below.

The cylindrical inner surface 64 has an inner diameter D₁ that is greater than the outer diameter D₂ of the first and second pipe P₁ and P₂. The difference between these diameters defines a gap between the outer surface of each of the first and second pipe P₁ and P₂ and the cylindrical inner surface 64 of the cylindrically shaped body 60. This gap provides space for the elastic material 98. The elastic material 98 provides a cushioning effect between the first and second pipe P₁ and P₂ and the cylindrical inner surface 64 of the cylindrically shaped body 60. In other words, the elastic material 98 eliminates noises that might occur by contact between the first and second pipe P₁ and P₂ and the cylindrical inner surface 64 of the cylindrically shaped body 60 and eliminates vibrations that might occur between the first and second pipe P₁ and P₂ and the cylindrical inner surface 64 of the cylindrically shaped body 60. The elastic material 98 also provides a means for slight mis-alignments between respective ones of the first and second pipe P₁ and P₂ and the cylindrical inner surface 64 of the cylindrically shaped body 60.

As shown in FIGS. 1-4 and 6-8, the cylindrically shaped body 60 includes a first fastening structure 102 that retains the first hollow pipe P₁ within the first hollow space 62a of the cylindrically shaped body 60. The cylindrically shaped body 60 also includes a second fastening structure 104 that retains the second hollow pipe P₂ within a second hollow space 62b of the cylindrically shaped body 60. The first fastening structure 102 defines projection 106. In the depicted embodiment, the projection 106 has a hexagonal shape. A central area of the projection 106 has an opening or elongated slot 108 that extends to and is open to the first hollow space 62a of the hollow interior 62 of the cylindrically shaped body 60. The elongated slot 108 is longer in the lengthwise direction L_{D} of the cylindrically shaped body 60 than in a direction perpendicular to the lengthwise direction L_{D}.

The second fastening structure 104 defines another projection 110. In the depicted embodiment, the projection 110 has a hexagonal shape. A central area of the projection 110 has circular opening 112 that extends to and is open to the second hollow space 62b of the hollow interior 62 of the cylindrically shaped body 60. Put another way, the first fastening structure 102 is on a first side of the wall 80 and the second fastening structure 104 is on an opposite side of the wall 80.

Fasteners F₁ and F₂ are inserted into the elongated slot 108 and the opening 112, respectively, for engagement with respective ones of the first pipe P₁ and the second pipe P₂. Preferably, the respective portions of the first pipe P₁ and the second pipe P₂ that are inserted into the cylindrically shaped body 60 include corresponding threaded openings that receive respective ones of the fasteners F₁ and F₂ (FIGS. 1, 4 and 7) thereby retaining the first pipe P₁ and the second pipe P₂ to and within the cylindrically shaped body 60.

The cylindrically shaped body 60 can be made of any of a variety of materials, such as, steel, an iron alloy, aluminum or an aluminum alloy. However preferably, the cylindrically shaped body 60 is made of a plastic/nylon material, such as polyamide 6.

The tube connector 20 can be used in any of a variety of applications. For example, the tube connector 20 can be used to connect the first pipe P₁ and the second pipe P₂ where the first pipe P₁ and the second pipe P₂ are part of a fence structure, a child's play structure (a junglegym structure) or other similar structures where two hollow pipes or tubes are joined together.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also as used herein to describe the above embodiment, the following directional terms “forward”, “rearward”, “above”, “downward”, “vertical”, “horizontal”, “below” and “transverse” as well as any other similar directional terms refer to those directions of a vehicle equipped with the tube connector. Accordingly, these terms, as utilized to describe the present invention should be interpreted relative to a vehicle equipped with the tube connector.

The term “configured” as used herein to describe a component, section or part of a structure that is constructed to carry out the desired function.

The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such features. Thus, the foregoing descriptions of the embodiments according to the present invention are provided for illustration only, and not for the purpose of limiting the invention as defined by the appended claims and their equivalents.

What is claimed is:

1. A tube connector comprising:
a cylindrically shaped body having a hollow interior defining a cylindrical inner surface therein, the cylindrically shaped body having a first end with a first opening and a second end with a second opening, the first and second openings both being open to the hollow interior, the cylindrically shaped body having a pipe aligning structure within the hollow interior spaced apart from the cylindrical inner surface dimensioned and shaped to receive a hollow pipe and center the hollow pipe with the hollow interior.

2. The tube connector according to claim 1, wherein
the hollow interior of the cylindrically shaped body includes a wall dividing a first portion of the hollow interior from a second portion of the hollow interior, the wall being perpendicular to a lengthwise direction of the cylindrically shaped body.

3. The tube connector according to claim 2, wherein
the wall divides the hollow interior into a first hollow area accessed by the first opening and a second hollow area accessed by the second opening.

4. The tube connector according to claim 2, wherein
the pipe aligning structure includes a projection extending from the wall within the first hollow area of the hollow interior.

5. The tube connector according to claim 4, wherein
the projection includes a first elongated projection that extends from the wall to proximate the first opening.

6. The tube connector according to claim 5 wherein
the projection further including a second elongated projection that extends from the wall to proximate the first opening such that the first and second elongated projections define an X shape as viewed through the first opening.

7. The tube connector according to claim 4, wherein
the pipe aligning structure includes a third elongated projection extending from the wall within the second hollow area of the hollow interior.

8. The tube connector according to claim 7, wherein
the pipe aligning structure includes a fourth elongated projection that extends from the wall to proximate the second opening such that the third and fourth elongated projections define an X shape as viewed through the second opening.

9. The tube connector according to claim 1 wherein
the cylindrically shaped body is made of a plastic/nylon material.

10. The tube connector according to claim 1 wherein
the cylindrically shaped body is made of polyamide 6.

11. The tube connector according to claim 1 wherein
the cylindrically shaped body is made of aluminum or an aluminum alloy.

12. The tube connector according to claim 1 wherein
the first opening of the first end of the cylindrically shaped body is dimensioned and shaped to receive a first hollow pipe and the second opening of the second end of the cylindrically shaped body is dimensioned and shaped to receive a second hollow pipe.

13. The tube connector according to claim 12 wherein
the cylindrically shaped body includes a first fastening structure that retains the first hollow pipe within a first hollow area of the cylindrically shaped body, and
the cylindrically shaped body includes a second fastening structure that retains the second hollow pipe within a second hollow area of the cylindrically shaped body.
